(19) United States
(12) Patent Application Publication
(10) Pub. No.: US 2024/0404750 A1
(43) Pub. Date: Dec. 5, 2024

(54) MULTILAYER CERAMIC CAPACITOR

(71) Applicant: Murata Manufacturing Co., Ltd., Nagaokakyo-shi (JP)

(72) Inventor: Ryo NISHIMURA, Nagaokakyo-shi (JP)

(21) Appl. No.: 18/800,362

(22) Filed: Aug. 12, 2024

Related U.S. Application Data
(63) Continuation of application No. PCT/JP2023/030832, filed on Aug. 27, 2023.

(30) Foreign Application Priority Data
Oct. 4, 2022 (JP) 2022-160612

(51) Int. Cl. H01G 4/005; H01G 4/12; H01G 4/224; H01G 4/232; H01G 4/30

(52) U.S. Cl. CPC H01G 4/005; H01G 4/1227; H01G 4/224; H01G 4/2325; H01G 4/30

(57) ABSTRACT

A multilayer ceramic capacitor includes a ceramic element including ceramic layers, first and second internal electrodes that are laminated in a height direction, a first main surface and a second main surface opposed in the height direction, a first and second end surface opposed in a length, and a first and second lateral surface opposed in a width direction, and a first and second external electrode on an outer surface of the ceramic element. Each of the first internal electrodes extends toward and is exposed at the first end surface, and is electrically connected with the first external electrode. Each of the second internal electrodes extends toward and is exposed at the second end surface, and is electrically connected with the second external electrode. The first and the second external electrodes have an L-shape. The second main surface includes embossed holes.

### CROSS REFERENCE TO RELATED APPLICATIONS

This application claims the benefit of priority to Japanese Patent Application No. 2022-160612, filed on Oct. 4, 2022, and is a Continuation Application of PCT Application No. PCT/JP2023/030832, filed on Aug. 27, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors are widely used in electronic devices and various devices including electronic appliances (hereinafter referred to as “electronic devices, etc.”). For example, Unexamined Japanese Patent Application Publication No. 2000-100647 discloses a multilayer ceramic capacitor having a typical structure.

Recently, reduction in size and high functionality of such electronic devices, etc., have been rapidly progressing. The reduction in size of such electronic devices, etc., has resulted in an extremely small internal volume (space volume) of such electronic devices, etc., which house electronic circuits composed of electronic components. In addition, the number of electronic components necessary for configuring an electronic circuit has rapidly increased due to the high functionality of such electronic devices, etc.

Therefore, as such electronic devices, etc., are reduced in size and more sophisticated, electronic components constituting the electronic circuit are also required to be reduced in size. For example, regarding multilayer ceramic capacitors, extremely thin products in each of which a ceramic element body has a thickness of several tens of um have been put into practical use.

As described above, with reduction in size and high functionality of electronic devices, etc., reduction in size, thinning of electronic components is particularly required. However, thinning of multilayer ceramic capacitors may cause a decrease in mechanical strength against an external force.

That is, in many cases, multilayer ceramic capacitors, which are surface mount type electronic components, are suctioned by a nozzle of a mounter device and are carried to a predetermined position such as a substrate to be mounted. At this time, in the thinned multilayer ceramic capacitors, cracks (including crack, fracture, defect, and the like) may occur in the ceramic element body due to the impact of the nozzle. When cracks occur in the ceramic element body, IR (insulation resistance) failure may occur in the multilayer ceramic capacitors due to moisture intrusion from the outside.

In addition, the multilayer ceramic capacitors are often sealed with a resin after being mounted on a substrate, etc. At this time, the bonding strength between the top surface (second main surface) of the ceramic element bodies of the mounted multilayer ceramic capacitors and the resin may become insufficient.

### SUMMARY OF THE INVENTION

Example embodiments of the present invention provide multilayer ceramic capacitors that are each able to reduce or prevent an occurrence of cracks, etc., in a ceramic element body even when an impact is applied to the ceramic element body by a nozzle, for example, when the ceramic element body is adsorbed by the nozzle of a mounter device. Further, example embodiments of the present invention provide multilayer ceramic capacitors each having a high bonding strength between a top surface (second main surface) of the ceramic element body and a resin when the multilayer ceramic capacitor is mounted on a substrate, etc., and further sealed with the resin.

An example embodiment of the present invention provides a multilayer ceramic capacitor that includes a ceramic element body including ceramic layers, first internal electrodes and a second internal electrodes that are laminated in a height direction, a first main surface and a second main surface opposed to each other in the height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction, and a first external electrode and a second external electrode on an outer surface of the ceramic element body, in which each of the first internal electrodes extends toward and is exposed at the first end surface, and is electrically connected with the first external electrode, each of the second internal electrodes extends toward and is exposed at the second end surface, and is electrically connected with the second external electrode, when a cross section parallel or substantially parallel to the first lateral surface and the second lateral surface is viewed, the first external electrode has an L-shape on the first end surface and the first main surface, and the second external electrode has an L-shape on the second end surface and the first main surface, and the second main surface includes embossed holes.

In a multilayer ceramic capacitors according to an example embodiment of the present invention, since the embossed holes are provided in the second main surface, even when an impact is applied by the nozzle, for example, when the multilayer ceramic capacitors are adsorbed by the nozzle of the mounter device, the multilayer ceramic capacitors are resistant to the impact, and the occurrence of cracks, etc., in the ceramic element body is reduced or prevented.

Further, in a multilayer ceramic capacitors according to an example embodiment of the present invention, since the embossed holes are provided in the second main surface, when the multilayer ceramic capacitors are mounted on a substrate, etc., and further sealed with a resin, the bonding strength between the second main surface of the ceramic element body and the resin is large. However, the multilayer ceramic capacitors of example embodiments of the present invention are not necessarily used by being sealed with the resin after being mounted on the substrate, etc., and may be used without being sealed with the resin.

The above and other elements, features, steps, characteristics and advantages of the present invention will become more apparent from the following detailed description of the example embodiments with reference to the attached drawings.

### BRIEF DESCRIPTION OF THE DRAWINGS

FIGS. 1A and 1B are each a perspective view of a multilayer ceramic capacitor 100 according to a first example embodiment of the present invention, and FIG. 1A shows the multilayer ceramic capacitor 100 viewed from a first main surface 1A and FIG. 1B shows the multilayer ceramic capacitor 100 viewed from a second main surface 1B.

FIG. 2 is a cross-sectional view of the multilayer ceramic capacitor 100, and shows a cross section taken along the line X-X indicated by an alternate long and short dash line arrow in FIG. 1A.

FIG. 3 is a cross-sectional view of a main portion of the multilayer ceramic capacitor 100.

FIGS. 4A to 4D are explanatory views showing steps in an example of a method of manufacturing the multilayer ceramic capacitor 100.

FIGS. 5E to 5J are continuations of FIG. 4D, and are explanatory views showing steps in an example of a method of manufacturing the multilayer ceramic capacitor 100.

FIG. 6 is a cross-sectional view of a multilayer ceramic capacitor 200 according to a second example embodiment of the present invention.

FIGS. 7A to 7D are explanatory views showing steps in an example of a method of manufacturing the multilayer ceramic capacitor 200.

FIGS. 8E to 8I are continuations of FIG. 7D, and are explanatory views showing steps in an example of the method of manufacturing the multilayer ceramic capacitor 200.

### DETAILED DESCRIPTION OF THE EXAMPLE EMBODIMENTS

Hereinafter, example embodiments of the present invention will be described with reference to the drawings.

Each example embodiment of the present invention is presents an example of the present invention, and the present invention is not limited to the contents of the example embodiments. Further, it is possible to implement the present invention by combining the contents described in different example embodiments, and such implementations are also encompassed in the present invention. In addition, the drawings are to help understanding of the specification and may be schematically drawn, and the drawn components or the ratio of the dimensions between the components may not coincide with the ratio of the dimensions described in the specification. In addition, components described in the specification may be omitted in the drawings or may be drawn with the number of components omitted.

### First Example Embodiment

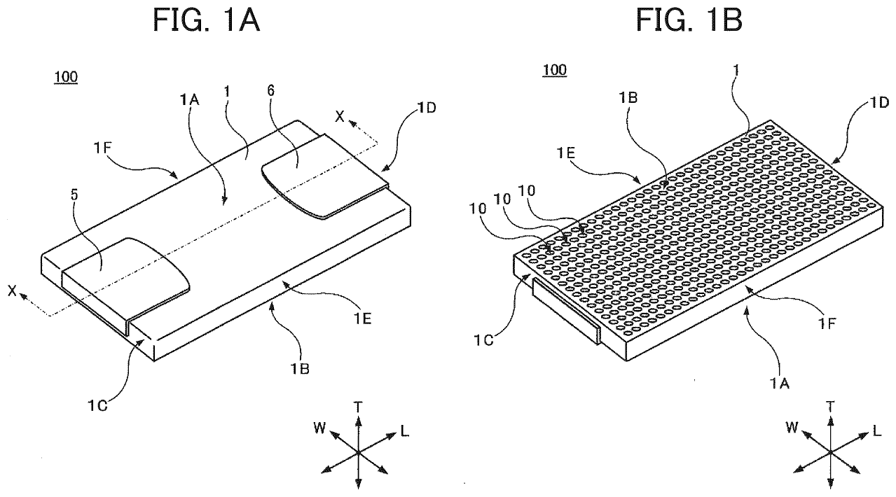

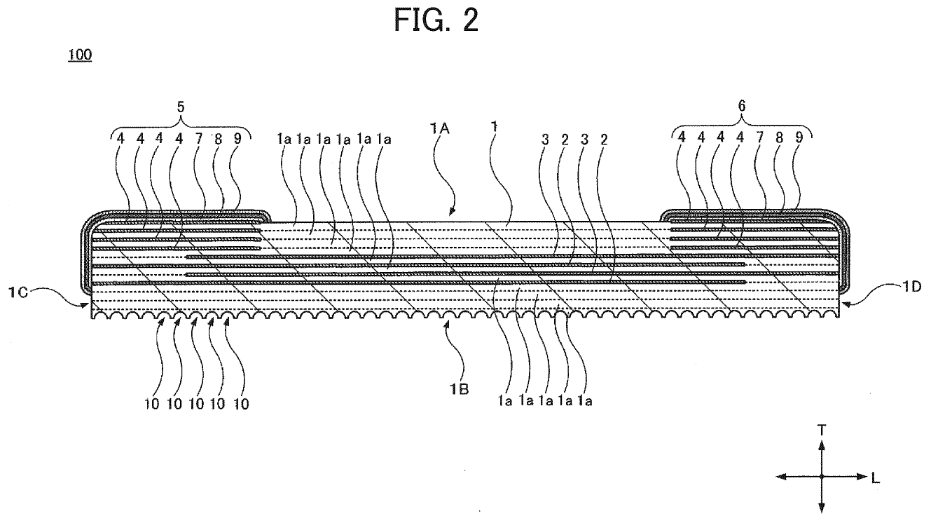

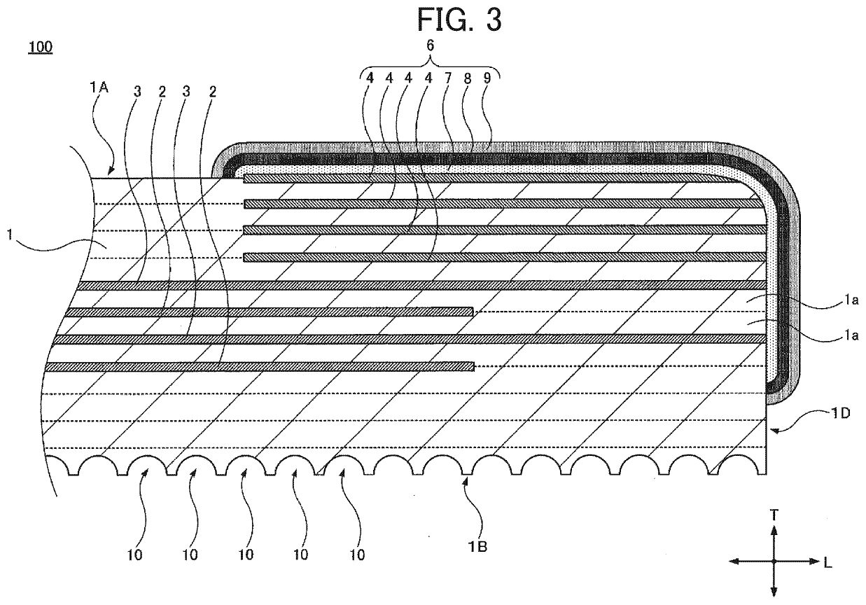

FIGS. 1A, 1B, 2, and 3 show a multilayer ceramic capacitor 100 according to a first example embodiment of the present invention. FIGS. 1A and 1B are perspective views of the multilayer ceramic capacitor 100, and FIG. 1A shows the multilayer ceramic capacitor 100 viewed from the first main surface 1A, and FIG. 1B shows the multilayer ceramic capacitor 100 viewed from the second main surface 1B. FIG. 2 is a cross-sectional view of the multilayer ceramic capacitor 100, and shows a cross section taken along the line X-X indicated by an alternate long and short dash line arrow in FIG. 1A. FIG. 3 is a cross-sectional view of a main portion of the multilayer ceramic capacitor 100.

In the drawings, a height direction T, a length direction L, and a width direction W of the multilayer ceramic capacitor 100 are shown, and these directions may be referred to in the following description. In the present example embodiment, the stacking (e.g., lamination) direction of ceramic layers 1a described later is defined as the height direction T of the multilayer ceramic capacitor 100.

The multilayer ceramic capacitor 100 includes a ceramic element body 1. The ceramic element body 1 preferably has a rectangular or substantially rectangular parallelepiped shape, and includes a first main surface 1A and a second main surface 1B opposed to each other in the height direction T, a first end surface 1C and a second end surface 1D opposed to each other in the length direction L, and a first lateral surface 1E and a second lateral surface 1F opposed to each other in the width direction W.

The specific dimensions of the ceramic element body 1 could be any desirable dimensions, but it is, for example, also preferable that one of the dimension in the length direction L or the dimension in the width direction W is about 1.0 mm or less and the other is about 0.5 mm or less, for example. It is also preferable that the dimension in the height direction T is, for example, about 0.1 mm or less. When the present invention is implemented, also in the multilayer ceramic capacitor 100 having a reduced size and thinner layers, since the plurality of embossed holes 10 are provided in the second main surface 1B of the ceramic element body 1, the impact resistance is improved as described later, such that the occurrence of cracks, etc., in the ceramic element body 1 is reduced or prevented.

The ceramic element body 1 includes a stack or lamination of ceramic layers 1a, first internal electrodes 2, second internal electrodes 3, and dummy internal electrodes 4. The ceramic layers 1a, the first internal electrodes 2, the second internal electrodes 3, and the dummy internal electrodes 4 are stacked or laminated in the height direction T of the ceramic element body 1.

As will be described later, each of the dummy internal electrodes 4 mainly defines and functions as a base external electrode for each of a first external electrode 5 and a second externa electrode 6, rather than generating a capacitance.

The material of the ceramic element body 1 (the ceramic layers 1a) may be any desirable material, for example, a dielectric ceramic including BaTiO₃ as a main component can be used. However, instead of BaTiO₃, dielectric ceramics mainly including of other materials such as, for example, CaTiO₃, SrTiO₃, and CaZrO₃ may be used.

The thickness of each of the ceramic layers 1a may be any desirable thickness, but may be, for example, about 0.3 μm to about 2.0 μm in the effective region of the capacitance formation in which the first internal electrodes 2 and the second internal electrodes 3 are provided.

The number of layers of the ceramic layers 1a is not specifically limited, but may be, for example, from 1 layer to 6000 layers in the effective region of capacitance formation in which the first internal electrodes 2 and the second internal electrodes 3 are provided.

The first internal electrode 2 and the second internal electrode 3 are not provided on both upper and lower sides of the ceramic element body 1. A protective layer (e.g., an outer layer) including only the ceramic layers 1a is provided on each of the upper and lower sides of the ceramic element body 1. However, in the present example embodiment, the dummy internal electrodes 4 are provided in the protective layers. The thickness of each of the protective layers may be any desirable thickness, but may be, for example, about 5 μm to about 150 μm. The thickness of each of the ceramic layers 1a of the protective layer may be larger than the thickness of each of the ceramic layers 1a in the effective region of the capacitance formation in which the first internal electrodes 2 and the second internal electrodes 3 are provided. The material of the ceramic layers 1a of the protective layer may be different from the material of the ceramic layers 1a in the effective region.

As can be appreciated from FIG. 2, each of the first internal electrodes 2 extends in the length direction L of the ceramic element body 1, and includes one end portion which is exposed at the first end surface 1C of the ceramic element body 1. Each of the second internal electrodes 3 extends in the length direction L of the ceramic element body 1, and includes one end portion which is exposed at the second end surface 1D of the ceramic element body 1. The first internal electrodes 2 and the second internal electrodes 3 are preferably alternately laminated.

The dummy internal electrodes 4 each defining and functioning as the base external electrode for each of the first external electrode 5 and the second external electrode 6 are smaller in dimension in the length direction L than the first internal electrodes 2 and the second internal electrodes 3. The dummy internal electrodes 4 each include one end portion which extends toward and is exposed at either the first end surface 1C or the second end surface 1D of the ceramic element body 1. Further, one of the dummy internal electrodes 4 provided closest to the first main surface 1A of the ceramic element body 1 is exposed at the first main surface 1A of the ceramic element body 1.

In addition, in each of the first external electrode 5 and the second external electrode 6, at least one of the dummy internal electrodes 4 may be provided closest to the first main surface 1A of the ceramic element body 1 and may be exposed at the first main surface of the ceramic element body 1.

The material of each of the main components (metal components) of the first internal electrodes 2, the second internal electrodes 3, and the dummy internal electrodes 4 are arbitrary, but, for example, Ni is used in the present example embodiment. However, other metals such as, for example, Cu, Ag, Pd, and Au may be used instead of Ni. Further, for example, Ni, Cu, Ag, Pd, Au, and the like may be alloys with other metals. The first internal electrodes 2, the second internal electrodes 3, and the dummy internal electrodes 4 may contain other components such as ceramics in addition to the metal components.

The thickness of each of the first internal electrodes 2, the second internal electrodes 3, and the dummy internal electrodes 4 is arbitrary, but may be, for example, about 0.3 μm to about 1.5 μm.

The first external electrode 5 and the second external electrode 6 are provided on the outer surface of the ceramic element body 1. When a cross section parallel or substantially parallel to the first lateral surface 1E and the second lateral surface 1F is viewed, the first external electrode 5 has an L-shape on the first end surface 1C and the first main surface 1A, and the second external electrode 6 has an L-shape on the second end surface 1D and the first main surface 1A. The first external electrode 5 is electrically connected to the first internal electrodes 2 at the first end surface 1C. The second external electrode 6 is electrically connected to the second internal electrodes 3 at the second end surface 1D.

The first external electrode 5 and the second external electrode 6 include the same or substantially same multilayer structure. In the present example embodiment, the first external electrode 5 and the second external electrode 6 each include, for example, in order from the bottom, a base external electrode, a Cu-plated external electrode layer 7 provided outside the base external electrode, a Ni-plated external electrode layer 8 provided outside the Cu-plated external electrode layer 7, and an Au-plated external electrode layer 9 provided outside the Ni-plated external electrode layer 8. However, the structures and materials of the first external electrode 5 and the second external electrode 6 are arbitrary, and are not limited to these structures and materials. In addition, dimensions such as the thickness, width, and length of the first external electrode 5 and the second external electrode 6 are also arbitrary, and may be freely set. In particular, various variations of the number, material, and dimensions of the plated external electrode layers may be employed.

Next, the base external electrode of each of the first external electrode 5 and the second external electrode 6 will be described. The base external electrode refers to a layer functioning as a base when a plated external electrode layer is formed on the outside thereof.

The base external electrode of the first external electrode 5 includes the end portions of the first internal electrodes 2 and the dummy internal electrodes 4 respectively extending toward and exposed at the first end surface 1C, and a main surface of a corresponding one of the dummy internal electrodes 4 exposed at the first main surface 1A. FIG. 2 exemplifies a structure in which the first external electrode 5 includes four layers of dummy internal electrodes 4 each functioning as the base external electrode, an upper main surface of a corresponding one of the dummy internal electrodes 4 provided closest to the first main surface 1A is exposed at the first main surface 1A, and the end portions of the remaining three layers of dummy internal electrodes 4 extend toward and are exposed at the first end surface 1C. However, the number of layers of the dummy internal electrodes 4 of the first external electrode 5 is arbitrary. The first external electrode 5 may include at least one layer which is provided closest to the first main surface 1A of the ceramic element body 1, and an upper main surface of the one layer may be exposed outside from the first main surface 1A of the ceramic element body 1.

Similarly, the base external electrode of the second external electrode 6 includes the end portions of the second internal electrodes 3 and the dummy internal electrodes 4 respectively extending toward and exposed at the second end surface 1D, and a main surface of a corresponding one of the dummy internal electrodes 4 exposed at the first main surface 1A. FIGS. 2 and 3 exemplify a structure in which the second external electrode 6 includes four layers of dummy internal electrodes 4 each defining and functioning as the base external electrode, an upper main surface of a corresponding one of the dummy internal electrodes 4 provided closest to the first main surface 1A is exposed at the first main surface 1A, and the end portions of the remaining three layers of dummy internal electrodes 4 extend toward and are exposed at the second end surface 1D. However, the number of layers of the dummy internal electrodes 4 of the second external electrode 6 is arbitrary. The second external electrode 6 may include at least one layer which is provided closest to the first main surface 1A of the ceramic element body 1, and an upper main surface of the one layer may be exposed outside from the first main surface 1A of the ceramic element body 1.

As described above, each of the end portions of the first internal electrodes 2 extending toward and exposed at the first end surface 1C of the ceramic element body 1 is a portion of the base external electrode of the first external electrode 5, and each of the end portions of the second internal electrodes 3 extending toward and exposed at the second end surface 1D of the ceramic element body 1 is a portion of the base external electrode of the second external electrode 6. For the purpose of avoiding the drawings being complicated, in FIGS. 2 and 3, the end portions of the first internal electrodes 2 are not shown as a portion of the first external electrode 5 and the end portions of the second internal electrodes 3 are not shown as a portion of the second external electrode 6 (extension lines from reference numeral “5” in the diagram showing the first external electrode 5 and reference numeral “6” in the diagram showing the second external electrode 6 are omitted.).

The base external electrode of each of the first external electrode 5 and the second external electrode 6 defines and functions as a base for forming the Cu-plated external electrode layer 7 on the outside thereof. As described above, in the present example embodiment, the end portions of the first internal electrodes 2 extending toward and exposed at the first end surface 1C, the end portions of the dummy internal electrodes 4, the end portions of the second internal electrode 3 extending toward and exposed at the second end surface 1D, and the end portions of the dummy internal electrodes 4 are also portions of the base external electrodes of the first external electrode 5 or the second external electrode 6. The end portions of the plurality of first internal electrodes 2 and the end portions of the plurality of dummy internal electrodes 4 extending linearly in the width direction W are exposed at the first end surface 1C. The end portions of the plurality of second internal electrodes 3 and the end portions of the plurality of dummy internal electrodes 4 extending linearly in the width direction W are exposed at the second end surface 1D. These end portions are exposed at intervals with an end portion of a corresponding one of the ceramic layers 1a extending linearly in the width direction W interposed therebetween. Even if the end portions of the first internal electrodes 2, the end portions of the second internal electrodes 3 and the end portions of the dummy internal electrodes 4 are provided at intervals, they define and function as bases when a plated external electrode layer is formed.

Each of the first external electrode 5 and the second external electrode 6 preferably includes, for example, a Cu-plated external electrode layer 7 outside the base external electrode. The Cu-plated external electrode layer 7 mainly defines and functions to improve moisture resistance. It is also preferable that the Cu-plated external electrode layer 7 includes, for example, Ni. In this case, dissolution of the external electrode layer into the solder can be reduced or prevented.

Each of the first external electrode 5 and the second external electrode 6 preferably includes, for example, a Ni-plated external electrode layer 8 outside the Cu-plated external electrode layer 7. The Ni-plated external electrode layer 8 mainly defines and functions to improve solder heat resistance and bonding properties. It is also preferable that the Ni-plated external electrode layer 8 includes, for example, P. In this case, the mechanical strength of the external electrode layer can be improved.

Each of the first external electrode 5 and the second external electrode 6 preferably includes, for example, the Au-plated external electrode layer 9 outside the Ni-plated external electrode layer 8. The Au-plated external electrode layer 9 mainly functions to improve wettability of the external electrode layer to solder.

In the multilayer ceramic capacitor 100 of the present example embodiment, R dimensions of a ridge line where the first main surface 1A and the first end surface 1C are in contact with each other, a ridge line where the first main surface 1A and the second end surface 1D are in contact with each other, a ridge line where the first main surface 1A and the first lateral surface 1E are in contact with each other, and a ridge line where the first main surface 1A and the second lateral surface 1F are in contact with each other are respectively larger than R dimensions of a ridge line where the second main surface 1B and the first end surface 1C are in contact with each other, a ridge line where the second main surface 1B and the second end surface 1D are in contact with each other, a ridge line where the second main surface 1B and the first lateral surface 1E are in contact with each other, and a ridge line where the second main surface 1B and the second lateral surface 1F are in contact with each other. It is preferable that the R dimensions (e.g., ridge dimensions) of the ridge line where the first main surface 1A and the first end surface 1C are in contact with each other, the ridge line where the first main surface 1A and the second end surface 1D are in contact with each other, the ridge line where the first main surface 1A and the first lateral surface 1E are in contact with each other, and the ridge line where the first main surface 1A and the second lateral surface 1F are in contact with each other are, respectively, about 1 μm or more and about 10 μm or less, for example. On the other hand, it is preferable that the R dimensions of the ridge line where the second main surface 1B and the first end surface 1C are in contact with each other, the ridge line where the second main surface 1B and the second end surface 1D are in contact with each other, the ridge line where the second main surface 1B and the first lateral surface 1E are in contact with each other, and the ridge line where the second main surface 1B and the second lateral surface 1F are in contact with each other are less than about 1 μm, for example.

In the multilayer ceramic capacitor 100 of the present example embodiment, the first main surface 1A of the ceramic element body 1 including the first external electrode 5 and the second external electrode 6 refers to a mounting surface for a substrate, etc. In the multilayer ceramic capacitor 100, the R dimensions of the ridge line where the first main surface 1A and the first end surface 1C are in contact with each other, the ridge line where the first main surface 1A and the second end surface 1D are in contact with each other, the ridge line where the first main surface 1A and the first lateral surface 1E are in contact with each other, and the ridge line where the first main surface 1A and the second lateral surface 1F are in contact with each other are large (because its roundness is large). Therefore, when the multilayer ceramic capacitor 100 is provided (e.g., placed) on the substrate, etc., for mounting, even when these ridge lines or corners where the first main surface 1A and two surfaces selected from the first end surface 1C, the second end surface 1D, the first lateral surface 1E, and the second lateral surface 1F collide with the substrate, etc., the occurrence of cracks, etc., in the ceramic element body 1 is reduced or prevented.

As described above, it is preferable that the R dimensions of the ridge line where the first main surface 1A and the first end surface 1C are in contact with each other, the ridge line where the first main surface 1A and the second end surface 1D are in contact with each other, the ridge line where the first main surface 1A and the first lateral surface 1E are in contact with each other, and the ridge line where the first main surface 1A and the second lateral surface 1F are in contact with each other are, respectively, about 1 μm or more and about 10 μm or less, for example. This is because, when the R dimension is less than about 1 μm, the advantageous effect of reducing or preventing the occurrence of cracks, etc., in the ceramic element body 1 is small. On the other hand, when the R dimension exceeds about 10 μm, the substantial volume of the ceramic element body 1 decreases, which may adversely affect the formation of the first internal electrodes 2 and the second internal electrodes 3 and reduce the capacitance of the multilayer ceramic capacitor 100.

In the multilayer ceramic capacitor 100 of the present example embodiment, a plurality of embossed holes 10 are provided in the second main surface 1B of the ceramic element body 1. In the present example embodiment, a plurality of embossed holes 10 having the same or substantially same shape and the same or substantially same dimension are provided in the second main surface 1B of the ceramic element body 1 and aligned in the length direction L and the width direction W.

In the present example embodiment, an embossed hole refers to, for example, a recessed hole having a bottom. The recessed surface may be hemispherical or non-hemispherical. The dimensions, the number, the arrangement, the intervals, the regions to be provided, and the like of the embossed holes 10 are arbitrary, and can be appropriately set. Any method may be applied for the method of forming the embossed holes 10. Whether or not the embossed holes 10 are provided in the second main surface 1B can be easily checked by comparing with other surfaces (for example, the first main surface 1A) of the ceramic element body 1.

In the multilayer ceramic capacitor 100, the second main surface 1B of the ceramic element body 1 refers to a surface to be adsorbed by, for example, a nozzle of a mounter device at the time of mounting, and is a surface to which an impact may be applied by the nozzle. In the multilayer ceramic capacitor 100 of the present example embodiment, the plurality of embossed holes 10 are provided in the second main surface 1B of the ceramic element body 1. Therefore, even when an impact is applied by the nozzle or the like, the multilayer ceramic capacitor is resistant to the impact, and occurrence of cracks, etc., in the ceramic element body 1 is reduced or prevented. In addition, the impact resistance of the ceramic element body 1 can be improved favorably if the embossed holes 10 are fine enough to fit into the ceramic layer 1a having a depth of about one to several ten layers. However, when the depth of each of the embossed holes 10 becomes too large, the strength of the entire ceramic element body 1 may be reduced. Therefore, the depth of each of the embossed holes 10 needs not to be too large.

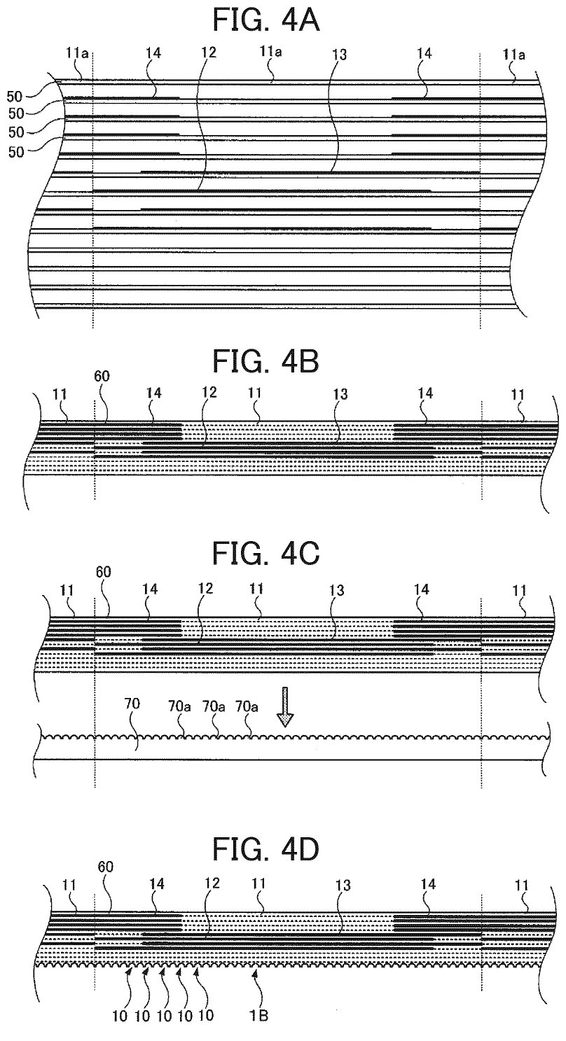

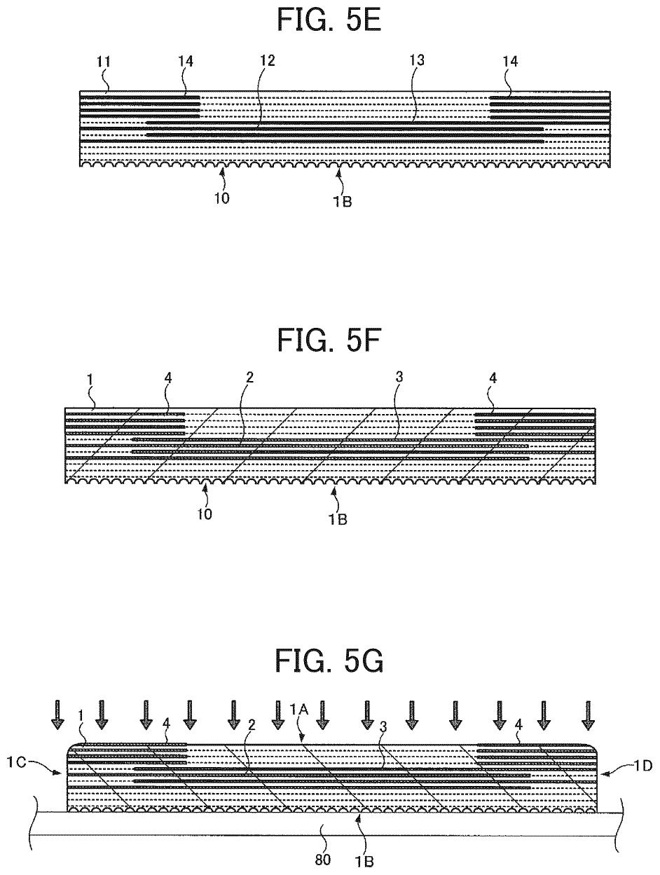

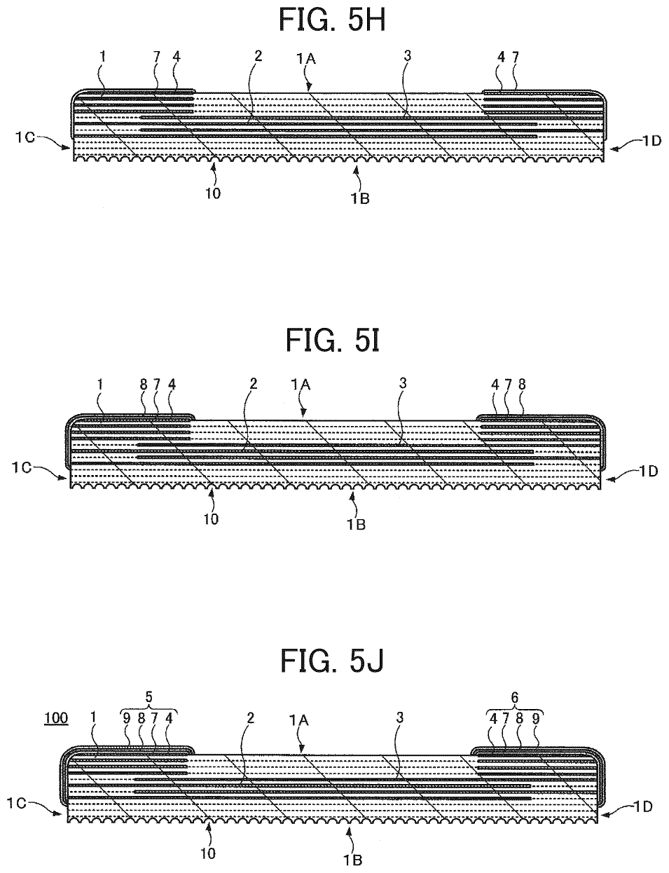

The multilayer ceramic capacitor 100 of the present example embodiment can be manufactured, for example, by the method shown in FIGS. 4A to 5J.

First, ceramic green sheets 11a for producing the ceramic layer 1a of the ceramic element body 1 shown in FIG. 4A are prepared. The ceramic green sheets 11a are prepared as mother ceramic green sheets 50 in which a large number of ceramic green sheets 11a are arranged in a matrix in order to collectively manufacture a large number of multilayer ceramic capacitors 100.

Although illustration is omitted, first, for example, a dielectric ceramic powder, a binder resin, a solvent, and the like are preferably prepared, and then these are wet-mixed to prepare a ceramic slurry.

Next, the ceramic slurry is applied onto the carrier film in a sheet shape using, for example, a die coater, a gravure coater, a microgravure coater, or the like, and dried to produce the mother ceramic green sheets 50.

Next, as shown in FIG. 4A, an electrically conductive paste 12 for forming the first internal electrodes 2, an electrically conductive paste 13 for forming the second internal electrodes 3, and an electrically conductive paste 14 for forming the dummy internal electrodes 4, which are prepared in advance, are applied (for example, printed) to the main surface of predetermined ceramic green sheets 11a of the mother ceramic green sheet 50 in a desired pattern shape. As the electrically conductive paste, for example, the mixture of a solvent, a binder resin, a metal powder (for example, Ni powder), and the like can be used.

Next, as shown in FIG. 4B, the mother ceramic green sheets 50 are laminated in a predetermined order and pressure-bonded to produce a mother unfired ceramic element body 60 in which a large number of unfired ceramic element bodies 11 are arranged in a matrix.

Next, as shown in FIG. 4C, a jig 70 in which a plurality of protruding portions 70a are provided on the upper main surface is prepared. Subsequently, the lower main surface of the mother unfired ceramic element body 60 is pressed against the plurality of protruding portions 70a of the jig 70. As a result, as shown in FIG. 4D, the plurality of embossed holes 10 are formed in the second main surface 1B of each unfired ceramic element body 11 of the mother unfired ceramic element body 60.

Next, as shown in FIG. 5E, the mother unfired ceramic element body 60 is cut into individual unfired ceramic element bodies 11.

Next, the unfired ceramic element body 11 is fired with a predetermined profile to produce the ceramic element body 1 shown in FIG. 5F. At this time, inside the ceramic element body 1, the electrically conductive paste 12 is simultaneously fired to form the first internal electrodes 2, the electrically conductive paste 13 is simultaneously fired to form the second internal electrodes 3, and the electrically conductive paste 14 is simultaneously fired to form the dummy internal electrodes 4.

Next, as illustrated in FIG. 5G, a jig 80 is prepared. Then, the second main surface 1B of the ceramic element body 1 is fixed to the upper main surface of the jig 80. Subsequently, for example, sandblasting is performed to shave the first main surface 1A of the ceramic element body 1, and the main surface on the upper side of the dummy internal electrode 4 provided closest to the first main surface 1A of the ceramic element body 1 is exposed at the first main surface 1A of the ceramic element body 1.

At this time, the ridge line where the first main surface 1A and the first end surface 1C are in contact with each other, the ridge line where the first main surface 1A and the second end surface 1D are in contact with each other, the ridge line where the first main surface 1A and the first lateral surface 1E are in contact with each other, and the ridge line where the first main surface 1A and the second lateral surface 1F are in contact with each other are respectively cut down and rounded simultaneously, such that the R dimensions of the ridge line where the first main surface 1A and the first end surface 1C are in contact with each other, the ridge line where the first main surface 1A and the second end surface 1D are in contact with each other, the ridge line where the first main surface 1A and the first lateral surface 1E are in contact with each other, and the ridge line where the first main surface 1A and the second lateral surface 1F are in contact with each other are respectively larger than the R dimensions of the ridge line where the second main surface 1B and the first end surface 1C are in contact with each other, the ridge line where the second main surface 1B and the second end surface 1D are in contact with each other, the ridge line where the second main surface 1B and the first lateral surface 1E are in contact with each other, and the ridge line where the second main surface 1B and the second lateral surface 1F are in contact with each other (the roundness becomes larger).

Next, as shown in FIG. 5H, the end portions of the first internal electrodes 2, the second internal electrodes 3, and the dummy internal electrodes 4 extending toward and exposed at the first end surface 1C and the second end surface 1D, and the upper main surfaces of corresponding ones of the dummy internal electrodes 4 exposed at the first main surface 1A are used as base external electrodes, and electroless plating is performed on the surfaces of these base external electrodes after applying a predetermined catalyst as necessary to form the Cu-plated external electrode layers 7.

Next, as shown in FIG. 5I, a predetermined catalyst is applied to the outside of the Cu-plated external electrode layer 7 as necessary, and then electroless plating is performed to form the Ni-plated external electrode layers 8.

Next, as shown in FIG. 5J, a predetermined catalyst is applied to the outside of the Ni-plated external electrode layer 8 as necessary, and then electroless plating is performed to form the Au-plated external electrode layers 9. As described above, the first external electrode 5 is formed in the L-shape on the first end surface 1C and the first main surface 1A of the ceramic element body 1, and the second external electrode 6 is formed in the L-shape on the second end surface 1D and the first main surface 1A of the ceramic element body 1, such that the multilayer ceramic capacitor 100 according to the first example embodiment is completed.

### Second Example Embodiment

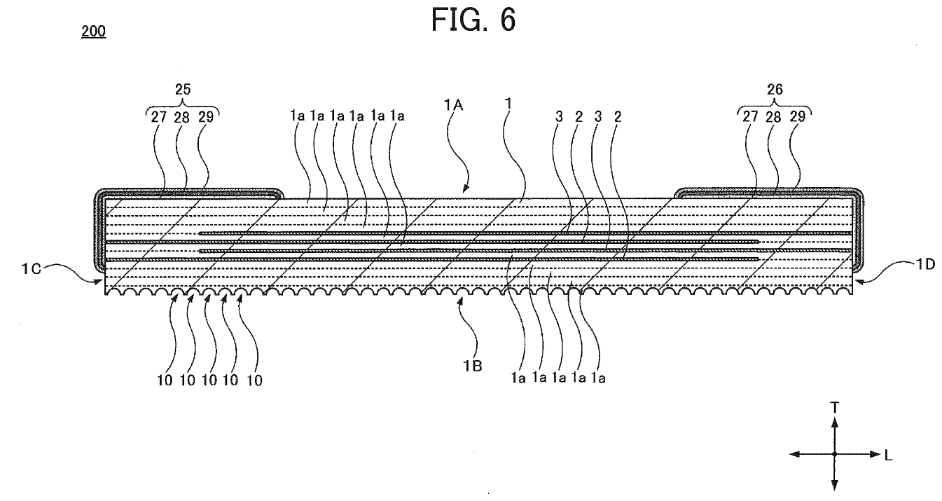

FIG. 6 shows a multilayer ceramic capacitor 200 according to a second example embodiment of the present invention. FIG. 6 is a cross-sectional view of the multilayer ceramic capacitor 200.

In the multilayer ceramic capacitor 200 according to the second example embodiment, a portion of the configuration of the multilayer ceramic capacitor 100 according to the first example embodiment described above is modified.

Specifically, in the multilayer ceramic capacitor 100, in the ceramic element body 1, the R dimensions of the ridge line where the first main surface 1A and the first end surface 1C are in contact with each other, the ridge line where the first main surface 1A and the second end surface 1D are in contact with each other, the ridge line where the first main surface 1A and the first lateral surface 1E are in contact with each other, and the ridge line where the first main surface 1A and the second lateral surface 1F are in contact with each other are respectively larger than the R dimensions of the ridge line where the second main surface 1B and the first end surface 1C are in contact with each other, the ridge line where the second main surface 1B and the second end surface 1D are in contact with each other, the ridge line where the second main surface 1B and the first lateral surface 1E are in contact with each other, and the ridge line where the second main surface 1B and the second lateral surface 1F are in contact with each other. In the multilayer ceramic capacitor 200, the R dimensions of the ridge line where the first main surface 1A and the first end surface 1C are in contact with each other, the ridge line where the first main surface 1A and the second end surface 1D are in contact with each other, the ridge line where the first main surface 1A and the first lateral surface 1E are in contact with each other, and the ridge line where the first main surface 1A and the second lateral surface 1F are in contact with each other are the same or substantially the same as the R dimensions of the ridge line where the second main surface 1B and the first end surface 1C are in contact with each other, the ridge line where the second main surface 1B and the second end surface 1D are in contact with each other, the ridge line where the second main surface 1B and the first lateral surface 1E are in contact with each other, and the ridge line where the second main surface 1B and the second lateral surface 1F are in contact with each other.

As a result, when the multilayer ceramic capacitor 100 and the multilayer ceramic capacitor 200 are compared with each other, the R dimensions of the ridge line where the first main surface 1A and the first end surface 1C are in contact with each other, the ridge line where the first main surface 1A and the second end surface 1D are in contact with each other, the ridge line where the first main surface 1A and the first lateral surface 1E are in contact with each other, and the ridge line where the first main surface 1A and the second lateral surface 1F are in contact with each other in the ceramic element body 1 of the multilayer ceramic capacitor 200 are smaller than the R dimensions of the ridge line where the first main surface 1A and the first end surface 1C are in contact with each other, the ridge line where the first main surface 1A and the second end surface 1D are in contact with each other, the ridge line where the first main surface 1A and the first lateral surface 1E are in contact with each other, and the ridge line where the first main surface 1A and the second lateral surface 1F are in contact with each other in the ceramic element body 1 of the multilayer ceramic capacitor 100.

Specifically, in the multilayer ceramic capacitor 100, the dummy internal electrodes 4 are used as a portion of the base external electrode of each of the first external electrode 5 and the second external electrode 6. In the multilayer ceramic capacitor 200, the dummy internal electrodes 4 are omitted. In the multilayer ceramic capacitor 200, for example, a NiCr thin film layer 27 is provided by, for example, sputtering as a base external electrode of each of the first external electrode 25 and the second external electrode 26. The NiCr thin film layer 27 has high adhesion to the ceramic element body 1, and functions as an excellent base external electrode of each of the first external electrode 25 and the second external electrode 26.

In addition, in the multilayer ceramic capacitor 100, as the plated external electrode layers of each of the first external electrode 5 and the second external electrode 6, for example, the Cu-plated external electrode layer 7, the Ni-plated external electrode layer 8, and the Au-plated external electrode layer 9 are sequentially provided outside the base external electrode. In the multilayer ceramic capacitor 200, as the plated external electrode layers of the first external electrode 25 and the second external electrode 26, for example, the Ni-plated external electrode layer 28 and the Au-plated external electrode layer 29 are sequentially provided outside the NiCr thin film layer 27, which is the base external electrode.

The other configurations of the multilayer ceramic capacitor 200 are the same or substantially same as those of the multilayer ceramic capacitor 100.

Similarly to the multilayer ceramic capacitor 100, a plurality of embossed holes 10 are provided in the second main surface 1B of the ceramic element body 1 of the multilayer ceramic capacitor 200. Therefore, even if an impact is applied to the second main surface 1B of the ceramic element body 1 by a nozzle or the like at the time of mounting, the multilayer ceramic capacitor 200 is also resistant to the impact, and the occurrence of cracks, etc., in the ceramic element body 1 is reduced or prevented.

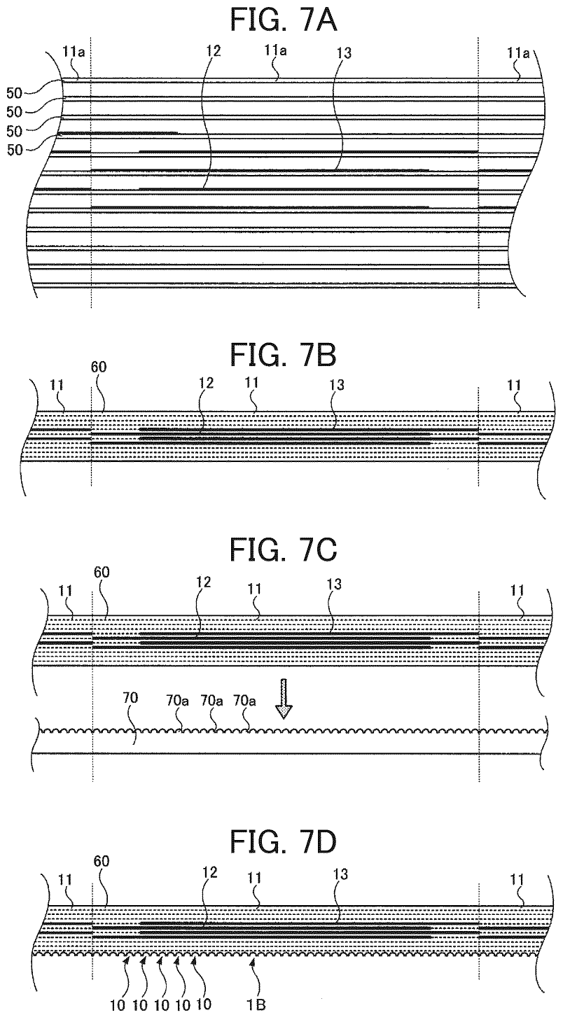

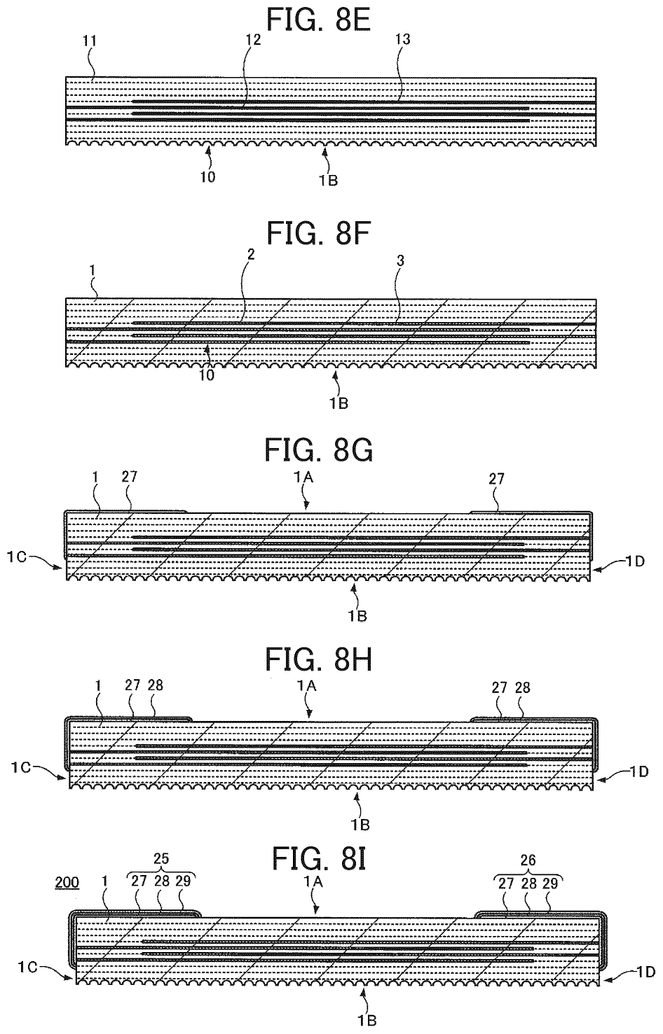

The multilayer ceramic capacitor 200 of the present example embodiment can be manufactured, for example, by the method shown in FIGS. 7A to 8I.

First, ceramic green sheets 11a for producing the ceramic layer 1a of the ceramic element body 1 shown in FIG. 7A is prepared. The ceramic green sheets 11a are prepared as mother ceramic green sheets 50 in order to collectively manufacture a large number of multilayer ceramic capacitors 100.

Next, as shown in FIG. 7A, an electrically conductive paste 12 for forming the first internal electrodes 2 and an electrically conductive paste 13 for forming the second internal electrodes 3, which are prepared in advance, are applied to the main surface of the predetermined ceramic green sheet 11a in the mother ceramic green sheet 50 in a desired pattern shape. Since the multilayer ceramic capacitor 200 does not include the dummy internal electrodes, the electrically conductive paste for forming the dummy internal electrodes is not applied.

Next, as shown in FIG. 7B, the mother ceramic green sheets 50 are laminated in a predetermined order and pressure-bonded to manufacture a mother unfired ceramic element body 60.

Next, as shown in FIG. 7C, the lower main surface of the mother unfired ceramic element body 60 is pressed against a jig 70 in which a plurality of protruding portions 70a are provided on the upper main surface, and as shown in FIG. 7D, a plurality of embossed holes 10 are formed in the second main surface 1B of each unfired ceramic element body 11.

Next, as shown in FIG. 8E, the mother unfired ceramic element body 60 is cut into individual unfired ceramic element bodies 11.

Next, the unfired ceramic element body 11 is fired with a predetermined profile to produce the ceramic element body 1 shown in FIG. 8F.

Next, as shown in FIG. 8G, as a base external electrode of each of the first external electrode 25 and the second external electrode 26, the NiCr thin film layer 27 is formed by sputtering.

Next, as shown in FIG. 8H, a predetermined catalyst is applied as necessary to the outside of the NiCr thin film layer 27, which is the base external electrode of each of the first external electrode 25 and the second external electrode 26, and then electroless plating is performed to form the Ni-plated external electrode layer 28.

Next, as shown in FIG. 8I, after a predetermined catalyst is applied to the outside of the Ni-plated external electrode layer 28 as necessary, electroless plating is performed to form the Au-plated external electrode layer 29. Thus, the first external electrode 25 is formed in the L-shape on the first end surface 1C and the first main surface 1A of the ceramic element body 1, and the second external electrode 26 is formed in the L-shape on the second end surface 1D and the first main surface 1A of the ceramic element body 1, such that the multilayer ceramic capacitor 200 according to the second example embodiment is completed.

The multilayer ceramic capacitors 100 and 200 according to the example embodiments have been described above. However, the present invention is not limited to the above-described contents, and various modifications can be made in accordance with the spirit of the present invention.

For example, in the above example embodiments, the jig 70 in which the plurality of protruding portions 70a are provided on the upper main surface is prepared, the second main surface 1B of the unfired ceramic element body 11 is pressed against the protruding portions 70a of the jig 70, and then the unfired ceramic element body 11 is fired to form the plurality of embossed holes 10 in the second main surface 1B. However, the method of forming the embossed holes 10 in the second main surface 1B of the ceramic element body 1 is not limited to this method, and various methods can be employed. As described above, in the present application, the embossed holes each refer to a recessed hole having a bottom, and the manufacturing method thereof is not limited. The embossed holes (e.g., recessed holes each having a bottom) may be hemispherical or non-hemispherical.

The embossed holes 10 are provided on the entire or substantially the entire surface of the second main surface 1B of the ceramic element body 1 in the above example embodiments. However, the embossed holes 10 may be provided in a partial region of the second main surface 1B of the ceramic element body 1.

In addition, in the above-described example embodiments, the plurality of embossed holes 10 having the same or substantially the same shape and the same or substantially the same dimension are provided on the second main surface 1B of the ceramic element body 1 in a state of being aligned in the length direction L and the width direction W of the ceramic element body 1. However, the shapes and the dimensions may be different in the individual embossed holes 10, or the plurality of embossed holes 10 may not be formed in a state of being aligned.

A multilayer ceramic capacitor according to one example embodiment of the present invention is as described in the section of Summary of the Invention.

In the multilayer ceramic capacitor, it is also preferable that the R dimensions of the ridge line where the first main surface and the first end surface are in contact with each other, the ridge line where the first main surface and the second end surface are in contact with each other, the ridge line where the first main surface and the first lateral surface are in contact with each other, and the ridge line where the first main surface and the second lateral surface are in contact with each other are respectively larger than the R dimensions of the ridge line where the second main surface and the first end surface are in contact with each other, the ridge line where the second main surface and the second end surface are in contact with each other, the ridge line where the second main surface and the first lateral surface are in contact with each other, and the ridge line where the second main surface and the second lateral surface are in contact with each other. In the multilayer ceramic capacitor according to one example embodiment, the first main surface is a mounting surface on the substrate, etc. However, in this case, since the R dimensions of the ridge line where the first main surface and the first end surface are in contact with each other, the ridge line where the first main surface and the second end surface are in contact with each other, the ridge line where the first main surface and the first lateral surface are in contact with each other, and the ridge line where the first main surface and the second lateral surface are in contact with each other are respectively large, when the multilayer ceramic capacitor is provided (placed) on the substrate, etc., for mounting, even when these ridge lines or corners where the first main surface and two surfaces selected from the first end surface, the second end surface, the first lateral surface, and the second lateral surface collide with the substrate, etc., the occurrence of cracks, etc., in the ceramic element body is reduced or prevented.

It is also preferable that the R dimension of each of the ridge line where the first main surface and the first end surface are in contact with each other, the ridge line where the first main surface and the first lateral surface are in contact with each other, the ridge line where the first main surface and the second end surface are in contact with each other, and the ridge line where the first main surface and the second lateral surface are in contact with each other is about 1 μm or more and about 10 μm or less. If the thickness is less than about 1 μm, the advantageous effect of reducing or preventing the occurrence of cracks, etc., in the ceramic element body when these ridge lines collide with the substrate, etc., is small. On the other hand, when the R dimension exceeds about 10 μm, the substantial volume of the ceramic element body decreases, which may adversely affect the formation of the first internal electrodes and the second internal electrodes and reduce the capacitance of the multilayer ceramic capacitor.

It is also preferable that the first external electrode and the second external electrode each include a base external electrode, and at least one plated external electrode layer provided outside the base external electrode. In this case, the base external electrode may be set as a base, and the plated external electrode layer may be easily formed on the outside of the base external electrode by, for example, electroless plating.

It is also preferable that the base external electrode includes a dummy internal electrode that is shorter than the plurality of first internal electrodes and the plurality of second internal electrodes in the length direction and is exposed at the first main surface of the ceramic element body. In this case, the first external electrode and the second external electrode each having relatively large area on the first main surface of the ceramic element body can be easily formed.

It is also preferable that the dummy internal electrode is made of the same material as those of the plurality of first internal electrodes and the second external electrode. In this case, it is not necessary to separately prepare a material for forming the dummy internal electrodes functioning as the base external electrode, such that the productivity of the multilayer ceramic capacitor is improved.

In this case, it is also preferable that the dummy internal electrode includes Ni as a main component. In this case, the ceramic element body, the first internal electrodes, the second external electrodes, and the dummy internal electrodes can be easily manufactured by so-called simultaneous firing.

It is also preferable that the base external electrode is a thin film. In this case, the base external electrode can be easily formed by sputtering, for example.

In this case, the thin film includes NiCr as a main component. In this case, the adhesion to the ceramic element body is high, such that the thin film is an excellent base external electrode for the first external electrode and the second external electrode.

It is also preferable that the plated external electrode layer includes at least one selected from a Cu-plated external electrode layer, a Ni-plated external electrode layer, and a Au-plated external electrode layer. In this case, various functions are exhibited in each plated external electrode layer, and an excellent first external electrode and an excellent second external electrode can be formed.

It is also preferable that the plated external electrode layer includes the Ni-plated external electrode layer provided outside the base external electrode and the Au-plated external electrode layer provided outside the Ni-plated external electrode layer. In this case, the Ni-plated external electrode layer can mainly function to improve solder heat resistance and bonding properties, and the Au-plated external electrode layer 9 can mainly function to improve wettability of the external electrode layer to solder.

It is also preferable that the plated external electrode layer includes the Cu-plated external electrode layer provided outside the base external electrode, the Ni-plated external electrode layer provided outside the Cu-plated external electrode layer, and the Au-plated external electrode layer provided outside the Ni-plated external electrode layer. In this case, the Cu-plated external electrode layer 7 can mainly function to improve moisture resistance, the Ni-plated external electrode layer can mainly function to improve solder heat resistance and bonding properties, and the Au-plated external electrode layer 9 can mainly function to improve wettability of the external electrode layer to solder.

It is also preferred that the Ni-plated external electrode layer includes P. In this case, the mechanical strength of the external electrode layer is improved.

It is also preferred that the Cu-plated external electrode layer includes Ni. In this case, dissolution of the external electrode layer into the solder can be reduced or prevented.

It is also preferable that one of a dimension in the length direction or a dimension in the width direction W is about 1.0 mm or less and the other is about 0.5 mm or less. It is also preferable that dimension in the height direction is about 0.1 mm or less. Even when the present invention is applied to a multilayer ceramic capacitor that is reduced in size and has thin layers as described above, the impact resistance is improved by the embossed holes provided in the second main surface of the ceramic element body, and the occurrence of cracks, etc., in the ceramic element body is reduced or prevented.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a ceramic element body including ceramic layers, first internal electrodes, and second internal electrodes that are laminated in a height direction, a first main surface and a second main surface opposed to each other in the height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction; and
a first external electrode and a second external electrode on an outer surface of the ceramic element body; wherein
each of the first internal electrodes extends toward, is exposed at the first end surface, and is electrically connected with the first external electrode;
each of the second internal electrodes extends toward, is exposed at the second end surface, and is electrically connected with the second external electrode;
when a cross section parallel or substantially parallel to the first lateral surface and the second lateral surface is viewed, the first external electrode has an L-shape on the first end surface and the first main surface, and the second external electrode has an L-shape on the second end surface and the first main surface; and
the second main surface includes embossed holes.

2. The multilayer ceramic capacitor according to claim 1, wherein R dimensions of a ridge line where the first main surface and the first end surface are in contact with each other, a ridge line where the first main surface and the second end surface are in contact with each other, a ridge line where the first main surface and the first lateral surface are in contact with each other, and a ridge line where the first main surface and the second lateral surface are in contact with each other are respectively larger than R dimensions of a ridge line where the second main surface and the first end surface are in contact with each other, a ridge line where the second main surface and the second end surface are in contact with each other, a ridge line where the second main surface and the first lateral surface are in contact with each other, and a ridge line where the second main surface and the second lateral surface are in contact with each other.

3. The multilayer ceramic capacitor according to claim 1, wherein the R dimension of each of the ridge line where the first main surface and the first end surface are in contact with each other, the ridge line where the first main surface and the second end surface are in contact with each other, the ridge line where the first main surface and the first lateral surface are in contact with each other, and the ridge line where the first main surface and the second lateral surface are in contact with each other is about 1 μm or more and about 10 μm or less.

4. The multilayer ceramic capacitor according to claim 1, wherein the first external electrode and the second external electrode each include:
a base external electrode; and
at least one plated external electrode layer provided outside the base external electrode.

5. The multilayer ceramic capacitor according to claim 4, wherein the base external electrode includes a dummy internal electrode that is shorter than the first internal electrodes and the second internal electrodes in the length direction and is exposed at the first main surface of the ceramic element body.

6. The multilayer ceramic capacitor according to claim 5, wherein the dummy internal electrode is made of a same material as materials of the first internal electrodes and the second external electrode.

7. The multilayer ceramic capacitor according to claim 5, wherein the dummy internal electrode includes Ni as a main component.

8. The multilayer ceramic capacitor according to claim 4, wherein the base external electrode is a thin film.

9. The multilayer ceramic capacitor according to claim 8, wherein the thin film includes NiCr as a main component.

10. The multilayer ceramic capacitor according to claim 4, wherein the plated external electrode layer includes at least one of a Cu-plated external electrode layer, a Ni-plated external electrode layer, and an Au-plated external electrode layer.

11. The multilayer ceramic capacitor according to claim 10, wherein the plated external electrode layer includes the Ni-plated external electrode layer provided outside the base external electrode and the Au-plated external electrode layer provided outside the Ni-plated external electrode layer.

12. The multilayer ceramic capacitor according to claim 10, wherein the plated external electrode layer includes the Cu-plated external electrode layer provided outside the base external electrode, the Ni-plated external electrode layer provided outside the Cu-plated external electrode layer, and the Au-plated external electrode layer provided outside the Ni-plated external electrode layer.

13. The multilayer ceramic capacitor according to claim 10, wherein the Ni-plated external electrode layer includes P.

14. The multilayer ceramic capacitor according to claim 10, wherein the Cu-plated external electrode layer includes Ni.

15. The multilayer ceramic capacitor according to claim 1, wherein one of a dimension in the length direction or a dimension in the width direction is about 1.0 mm or less and the other is about 0.5 mm or less.

16. The multilayer ceramic capacitor according to claim 1, wherein a dimension in the height direction is about 0.1 mm or less.

17. The multilayer ceramic capacitor according to claim 1, wherein a thickness of each of the ceramic layers is about 0.3 μm to about 2.0 μm.

18. The multilayer ceramic capacitor according to claim 1, wherein the embossed holes are recessed holes each including a bottom.
